(19) United States
(12) Patent Application Publication
(10) Pub. No.: US 2009/0018804 A1
(43) Pub. Date: Jan. 15, 2009

(54) Modelling a Phenomenon that has Spectral Data

(75) Inventors: Anthony Lee Senyard, Victoria (AU); Joel Edward Brakey, Victoria (AU)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: SCIENTIFIC ANALYTICS SYSTEMS PTY LTD., Port Melbourne (AU)

(21) Appl. No.: 11/791,766

(22) PCT Filed: Nov. 29, 2005
(86) PCT No.: PCT/AU05/01793

§ 371 Date: Sep. 11, 2008

(30) Foreign Application Priority Data
Nov. 29, 2004 (AU) 2004906819

(51) Int. Cl. G06F 17/10

(52) U.S. Cl. 703/2

(57) ABSTRACT

A method is disclosed for modelling a physical phenomenon that has associated spectral data. The method includes the step of obtaining the spectral data (12) on at least two samples (10) from a material, substrate or electrical activity such as electrical activity of a brain. The method includes performing an analysis of the samples of the phenomenon (15) and storing the spectral data and characteristic information in a library (14). The method includes generating from the library an individualized modelling equation as a function of the spectral data and characteristic information, wherein the modelling equation includes linear and non-linear dimensions and wherein the step of generating includes a type of kernel-learning means (17) for reducing at least the non-linear dimensions associated with the modelling equation. The method may include a validation step in which performance of the model may be assessed based on a simulation of real world use (18), ie. used to predict a property associated with a substance or to predict a physical phenomenon by utilizing the individualized modelling equation.

The present invention relates to spectral analysis and in particular relates to a method of modelling a physical phenomenon that has associated spectral data. The spectral data may be obtained from a material or substance or it may include electrical activity such as electrical activity of a brain. The method may derive information about the phenomenon such as a physical or chemical property associated with the material or substance or the nature of a brain or mental disorder.

The present invention has particular application in the field of analytical spectroscopy. The present invention will hereinafter be described with particular reference to this application although it is to be understood that it is not thereby limited to such a field of application.

A capacity to accurately predict a property associated with a material or substance such as its physical or chemical makeup or content can have many useful applications, particularly if this can be carried out remotely or non-invasively. Examples of applications for this technology include soil analysis for agriculture, mineralogy for mining and other purposes, plant and biological tissue analysis for agricultural, medical and other purposes, as well as numerous security, law enforcement and related applications.

When a material or substance is exposed to electromagnetic radiation, energy such as photons associated with the radiation can penetrate or reflect from a surface of the material or substance. The energy is reflected or transmitted in such a way that it may be seen and/or detected. The reflected or transmitted energy may combine to form spectra that contain within it, information that is specific to a physical or chemical property associated with the material or substance, such as its physical or chemical makeup or content.

However, the volume and detail of information in the spectra must be decoded in order to be correlated with the property of interest. The information is relatively complex because the process of reflection and/or transmission is a non-linear process and recovery of quantitative information from the resulting spectra may be difficult.

Traditional approaches to interpretation of spectra include use of human experts to interpret the spectra directly, linear regression to compare unknown spectra against a library of known spectra, construction of linear models to relate parts of spectra which characterize properties of interest in a substance as well as techniques which reduce spectra of a complex substance into a linear combination of spectra of simpler substances that may be present in the complex substance.

However, these approaches are problematic. Human experts are best at identifying pure substances not complex substances or compounds. Comparison of unknown spectra with known spectra using linear regression does not take into account known non-linear relationships between different parts of the spectra, while reduction of the spectra of a complex substance into a linear combination of the spectra of simpler substances does not result in the observed spectra for the complex substance.

An object of the present invention is to improve the accuracy and consistency of spectral analysis techniques.

Accuracy of spectral analysis techniques may be improved via the application of machine learning algorithms. Machine learning algorithms may be adapted to learn relationships including non-linear relationships between parts of spectra and a physical phenomenon such as a physical or chemical property of interest. This approach may provide a bridge between human experts who know what to look for in the spectra and comparisons involving libraries of known spectra.

According to one aspect of the present invention there is provided a method for modelling a substance that has associated spectral data, said method including the steps of:

i) exposing a first sample of said substance to electromagnetic radiation having a range of wavelengths to obtain reflected spectral data from said substance;
ii) performing an analysis of said first sample to obtain characteristic information associated with said substance such as a physical or chemical property;
iii) repeating steps (i) and (ii) at least once on a second or further sample of said substance and storing said spectral data and characteristic information in a library; and
iv) generating from said library an individualized modelling equation for said substance as a function of said spectral data and characteristic information, wherein said modelling equation includes linear and non-linear dimensions and wherein said step of generating includes kernel learning means for reducing at least said non-linear dimensions associated with said modelling equation.

The second and further samples of the substance preferably contain sufficient variability in the property of interest to produce spectral data that differs from or is at least not redundant when compared to the data stored in the library for other samples.

In some embodiments the step of generating may be performed on a majority subset of data and information stored in the library and a minority subset of the data and information may be removed for subsequent validation of the modelling equation. In one form the minority subset may comprise approximately 10 percent of the data and information stored in the library.

The electromagnetic radiation may include visible, near infra-red (NIR), mid infra-red (MIR) and far infra-red (FIR) frequencies and/or combinations of such radiation.

A known technique for analysing spectra is Independent Component Analysis (ICA). ICA is derived from Blind Source Separation used in acoustic analysis to separate mixed speech signals. Basically, this approach picks out relevant spectral information regarding a specific material property which is of interest. For example, where the substance is soil and the material property of interest is calcium carbonate (CaCO₃) content, there will be sub-bands of the spectra which correspond to CaCO₃ molecules present in the soil. However, these sub-bands are mixed with reflectance spectra of all the other molecules and elements present in the soil. ICA may be used to extract only sub-bands including combinations of sub-bands (hereinafter referred to as independent components) of the spectra which relate to CaCO₃. This is one of many techniques that may be applied to reduce the volume of information used in subsequent steps.

According to a further aspect of the present invention there is provided a method for modelling a physical phenomenon that has associated spectral data, said method including the steps of:

i) obtaining said spectral data;
ii) performing an analysis of said phenomenon to obtain characteristic information associated with said phenomenon;
iii) repeating steps (i) and (ii) at least once on a second or further example of said phenomenon and storing said spectral data and characteristic information in a library; and
iv) generating from said library an individualized modelling equation for said phenomenon as a function of said spectral data and characteristic information, wherein said modelling equation includes linear and non-linear dimensions and wherein said step of generating includes kernel learning means for reducing at least said non-linear dimensions associated with said modelling equation.

The second and further examples of the phenomenon preferably contain sufficient variability in the phenomenon of interest to produce spectral data that differs from or is at least not redundant when compared to the data stored in the library for other examples.

In some embodiments the said step of generating may be performed on a majority subset of data and information stored in the library and a minority subset of the data and information may be removed for subsequent validation of the modelling equation. In one form the minority subset may comprise approximately 10 percent of the data and information stored in the library.

The step of obtaining spectral data may include recording electrical activity associated with a brain of a mammal such as a patient with a brain or mental disorder. The characteristic information may include information about a brain, or mental disorder. The second and further examples may be obtained from patients with brain or mental disorders.

The electromagnetic radiation may include radio waves including extremely high frequency through to extremely low frequency radio waves and near ultraviolet and gamma rays and/or combinations of such radiation.

The kernel learning means may include a machine learning process or algorithm based on a connectionist approach to computation. The kernel learning means may include a support vector machine (SVM), relevance vector machine (RVM) or an artificial neural network (ANN) which can use kernel functions to determine non-linear relationships between identified independent components (inputs) and the material property of interest (output). ANNs, RVMs and SVMs may be used to create non-linear models through an iterative algorithm that may use a large number of input/output pairs as a basis for the model. ANNs, RVMs and SVMs fall into a category of artificial intelligence called machine learning, ie. they may “learn” the relationship between the inputs and outputs through repetition (not unlike rote learning). SVMs and RVMs are machine learning algorithms in which training is based on quadratic programming and includes a form of mathematical optimisation that typically has only one global minimum.

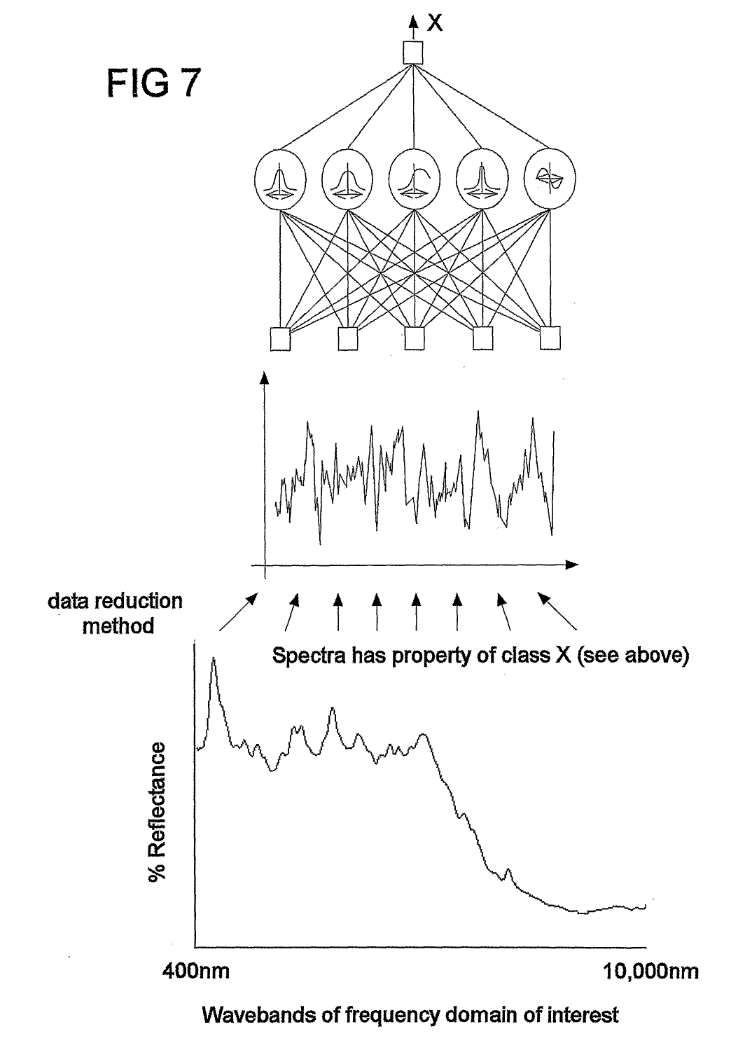

Referring to the soil example including ICA as a spectral data reduction technique, the amount of CaCO₃ will depend on a non-linear relationship between the independent components. The independent components may be used as training inputs to the ANNs, RVMs and SVMs. The actual content of CaCO₃ in the sample will still have to be determined by a direct method such as chemical analysis. The actual content may then be used as the target output value to be learnt. Alternatively, transformed or derived target output values may be used. For example the target output values may be transformed into members of fuzzy sets as described with reference to FIG. 7. In general, a statistically significant number of input-output pairs will be required to learn the relationship.

Once the machine learning process has learnt the relationship it may produce a calibrated model that may be tested on new or unseen samples or examples that were not presented during the learning process. The calibrated model may be used to predict a property associated with new or unseen samples of a substance or to predict a physical phenomenon associated with new or unseen examples of the phenomenon. The performance of the model on the new or unseen samples or examples may be used to determine accuracy and consistency of the model. Once a satisfactory level of performance has been achieved, the model may be used on live data. The model may be used to predict a property associated with a substance or to predict a physical phenomenon by utilizing the individualized modelling equation for the substance or phenomenon to predict the property or phenomenon.

A preferred embodiment of the present invention will now be described with reference to the accompanying drawings wherein:

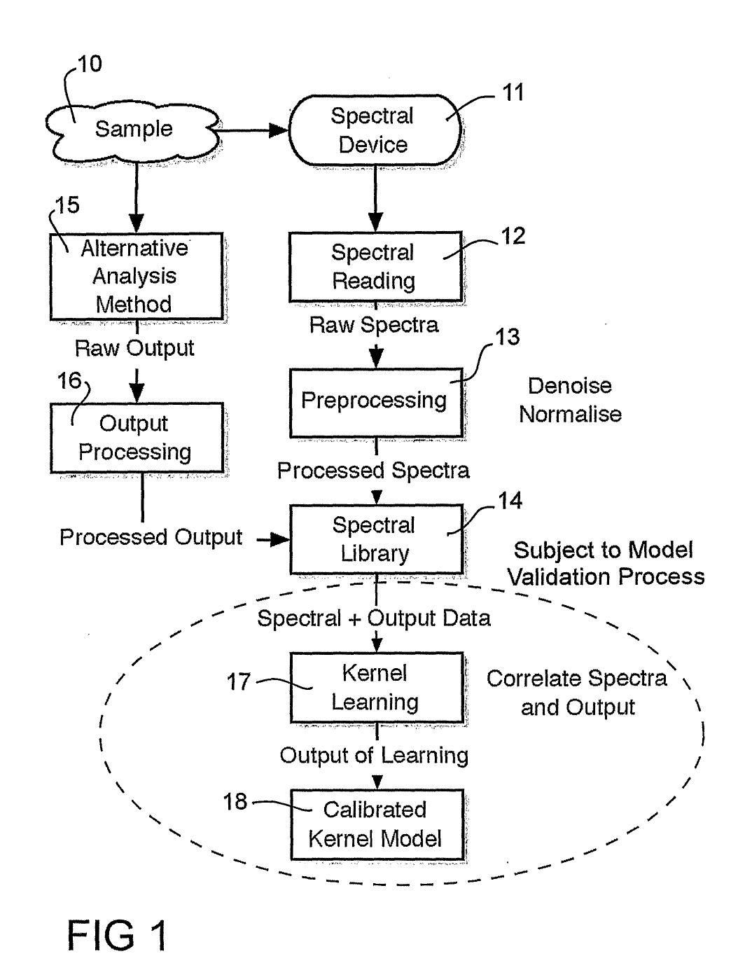

FIG. 1 shows a flow chart of a method for modelling a property of a substance;

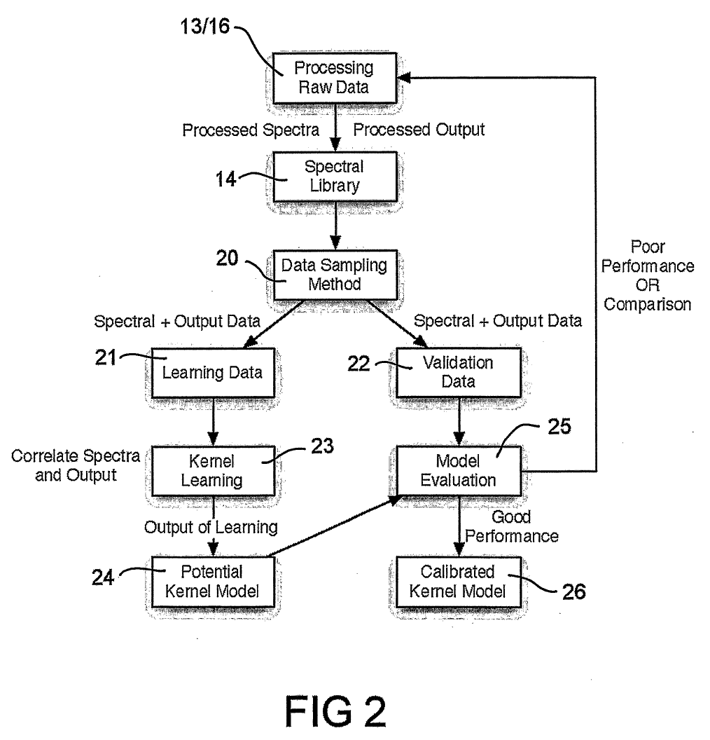

FIG. 2 shows a flow chart of a method for subjecting a model to a validation process;

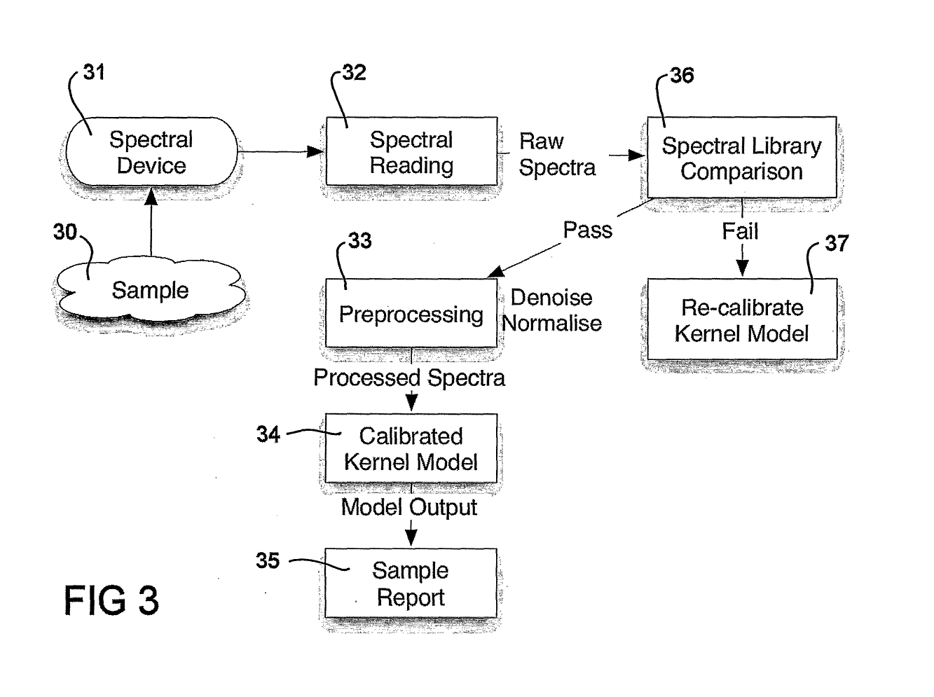

FIG. 3 shows a flow chart of a method for predicting a property of a substance using a Kernel model;

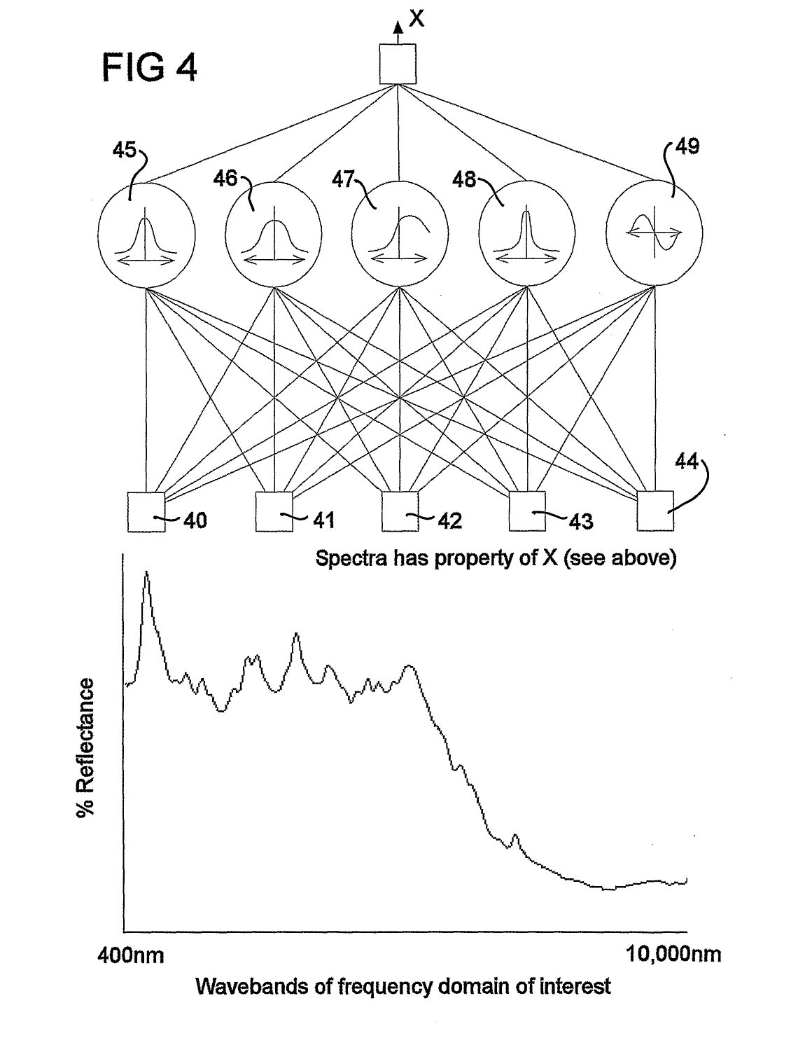

FIG. 4 shows raw spectra as inputs to a Kernel Model;

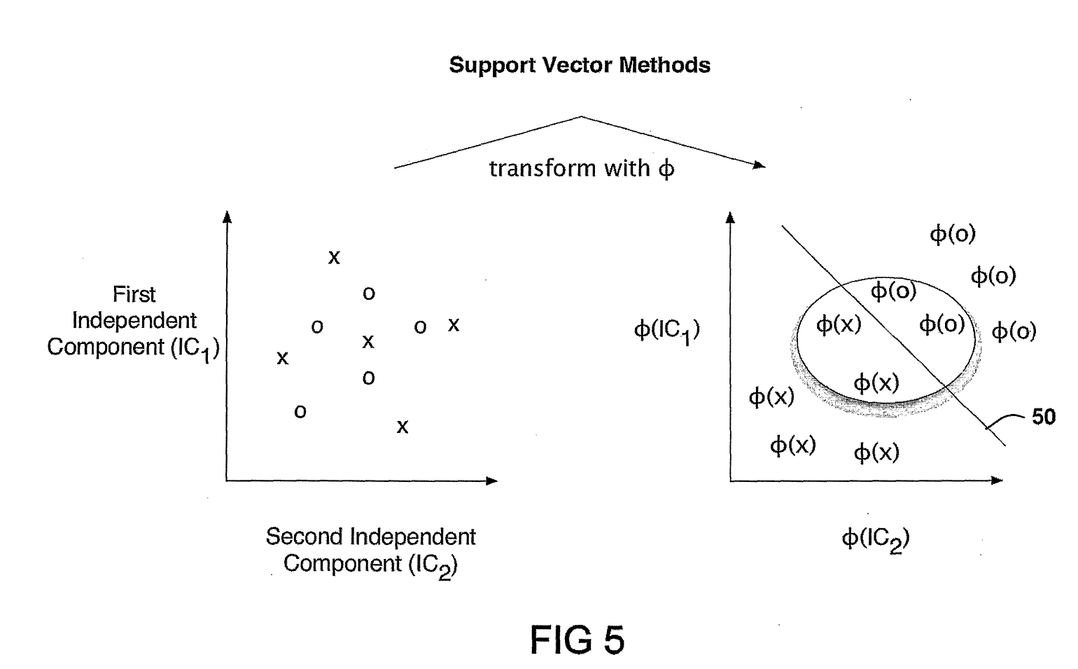

FIG. 5 shows a graphical representation of Kernel mapping using Support Vector Methods;

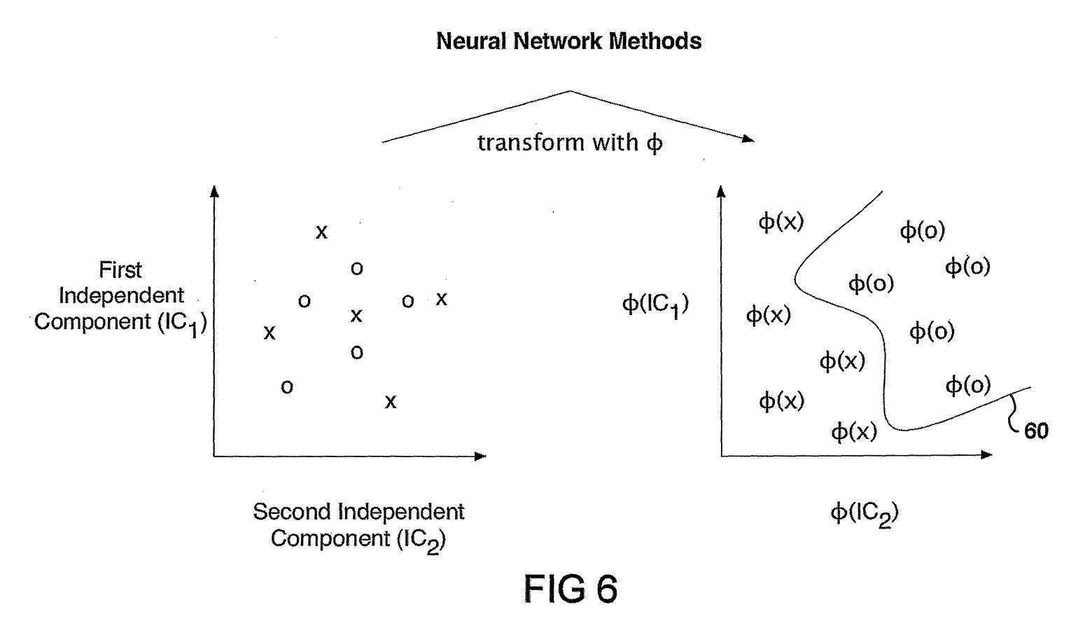

FIG. 6 shows a graphical representation of Kernel mapping using Neural Network Methods;

FIG. 7 shows transformed spectra as input; and

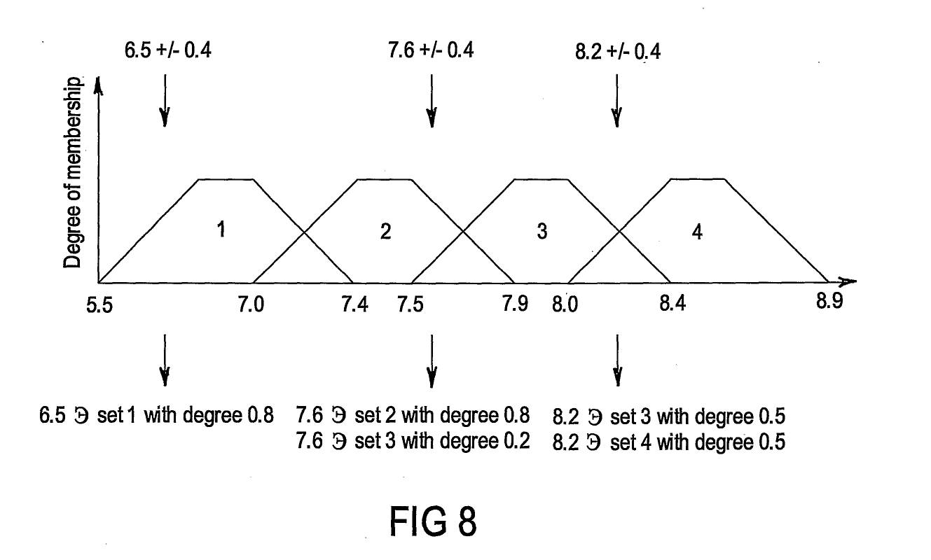

FIG. 8 shows examples of fuzzy set classification.

A flow chart of a method for modelling a property associated with a material or substance is shown in FIG. 1. The method includes obtaining via a spectral device 11 a spectral reading 12 of a sample 10 of a material or substance.

The spectral device 11 may include a spectrophotometer having a source of electromagnetic radiation. The source may include Visible/Near Infra Red (NIR)/Mid Infra Red (MIR)/Far Infra Red (FIR) radiation in a range of 400-700 nm/800-2500 nm/2500-50,000 nm/50,000-1,000,000 nm respectively. The sample may be exposed to the radiation in any suitable manner and by any suitable means. The spectral device 11 includes a detector for detecting spectral data reflected from the sample 10. The detector may output raw spectral data which is subjected to a preprocessing step 13. The preprocessing step 13 is included to enhance the modelling process including to normalize the raw spectral data and to filter noise and remove artifacts. The processed spectral data is stored in a spectral library 14.

An analysis of sample 10 is also performed by an alternative (non-spectral) analysis method 15, such as chemical analysis, to obtain characteristic information associated with the sample such as a physical or chemical property. The raw output from the alternative analysis method 15 is subjected to a processing step 16 to provide a processed output. The processing step 16 may include fuzzy set classification (refer FIG. 7) to mask the effect of errors introduced as a result of limitations and/or inaccuracies in the measurement associated with analysis method 15. The processed output is stored in the spectral library 14. The processed output is associated in the library with the processed spectral data obtained from sample 10 via spectral device 11. Steps 12 to 16 are repeated a plurality of times on different samples of the material or substance until a significant population of library entries is obtained. The population of library entries may be used to produce via a Kernel learning process 17 a calibrated Kernel Model 18. The Kernel learning process 17 may be based on a connectionist approach to computation and is described in further detail below. The Kernel learning process 17 may include an SVM, RVM and/or ANN using Kernel functions to determine a relationship between the associated data stored in spectral library 14. The output of the Kernel learning process 17 is a calibrated Kernel Model 18. The Kernel Model 18 is a modelling equation that represents an individualized calibration of the data stored in spectral library 14.

The Kernel Model 18 may be subjected to an optional validation process. The validation process is described below with reference to FIG. 2.

Referring to FIG. 2 the processed data collected in steps 13 and 16 is stored in spectral library 14 in a manner similar to that described with reference to FIG. 1. The first step in the validation process is to divide the processed data into two groups or sets. The data is divided into the two groups or sets by means of a proportional stratified data sampling method 20. Approximately 90 percent of the data may be placed in a learning data set 21 and approximately 10 percent of the data may be placed in a validation data set 22. One example of a stratified sampling method is given below.

In the following example 110 data points relating to pH of a substance are to be selected from a total of 1098 data points (ie. approximately 1/10^{th} or 10% of the data). The table below shows the total number of samples in each pH range and the number of samples selected from each pH range.

| pH range | No. in range | 1/10^{th} | Select No. | Actual sample fraction |
|---|---|---|---|---|
| 4.0-5.0 | 169 | 16.9 | 17 | 0.1006 |
| 5.0-6.0 | 147 | 14.7 | 15 | 0.1020 |
| 6.0-7.0 | 194 | 19.4 | 19 | 0.0979 |
| 7.0-8.0 | 213 | 21.3 | 21 | 0.0986 |
| 8.0-9.0 | 177 | 17.7 | 18 | 0.1017 |
| 9.0-10.0 | 198 | 19.8 | 20 | 0.1010 |
| Totals | 1098 | 109.8 | 110 | 0.1003 |

Stratified sampling requires that data is selected from each pH range. This may be done randomly but depends on whether replacement is used or not. Choosing randomly from a pH range is straight forward although a seed to the random selection function should be used to allow repeatability. The order of the selection is also not important. For example, in choosing 15 data points from the pH range 5.0-6.0, selecting the set of points:

{1, 4, 5, 19, 20, 43, 56, 91, 101, 119, 123, 134, 143, 151, 159}
is the same as:
{4, 1, 5, 19, 20, 43, 56, 91, 101, 119, 123, 134, 143, 151, 159}

The first set of learning data 21 is then used to produce via a Kernel learning process 23 (similar to Kernel learning process 17 in FIG. 1) a potential Kernel Model 24 (similar to Kernel Model 18 in FIG. 1).

The potential Kernel model 24 is now subjected to a model evaluation process 25. The potential Kernel model 24 is evaluated on the validation data 22 that is not used in the model creation process. This effectively simulates use of the model on unseen data in the real world. The model evaluation process 25 may include measures of correlation (R²) and root means square error (RMSE) to evaluate whether performance of the model is acceptable (good) or unacceptable (poor). The measures may determine, inter alia, consistency across different data sets and accuracy within a given data set.

If the performance of the model is good then the potential Kernel Model 24 may be selected as the calibrated Kernel model 26. The latter corresponds to calibrated Kernel model 18 in FIG. 1 but has been subjected to a validation process. Some or all of the data that was placed in the validation data set 22 may now be placed in the learning data set 21 and may be used to update and further enhance the calibrated Kernel model 26.

If the performance of the model is poor then a different machine learning process or algorithm may be applied in Kernel learning step 23 and/or new methods of processing the data may be attempted. Steps 20 to 25 may be repeated several times with the same or different processed data and/or with different Kernel learning methods as part of a process of comparison, evaluation of different models and/or determining the consistency of model performance across different data.

One example of a model evaluation process is described below with reference to a table of soil samples containing exchangeable Magnesium.

| Number of data sets | R² +/− std. dev. | RMSE +/− std. dev. |
|---|---|---|
| 3 | 0.8886 +/− 0.0245 | 0.8961 +/− 0.1045 |
| 4 | 0.9029 +/− 0.0166 | 0.8424 +/− 0.0428 |
| 5 | 0.8978 +/− 0.0156 | 0.8572 +/− 0.0585 |
| 6 | 0.9022 +/− 0.012 | 0.8505 +/− 0.0756 |
| 7 | 0.8945 +/− 0.0159 | 0.8774 +/− 0.0787 |
| 10 | 0.9067 +/− 0.0206 | 0.8223 +/− 0.0842 |
| 15 | 0.9044 +/− 0.0348 | 0.8211 +/− 0.1326 |
| 20 | 0.9110 +/− 0.0281 | 0.8035 +/− 0.1412 |
| 25 | 0.9108 +/− 0.0274 | 0.8138 +/− 0.1353 |
| 30 | 0.9103 +/− 0.0409 | 0.8031 +/− 0.1883 |
| 60 | 0.9184 +/− 0.0509 | 0.7783 +/− 0.2532 |
| 100 | 0.9314 +/− 0.0509 | 0.7732 +/− 0.2791 |

The total number of soil samples in the example is 1109. The number of data sets indicates the number of samples used in calculating RMSE and R². For example, the entry with 10 data sets indicates that 999 samples (ie. 90% of all data) are used to construct a model and 110 samples (ie. 10% of all data) are used as validation data for model evaluation. This is then repeated a number of times that corresponds to the number of data sets with different data used as the validation data. Continuing with the example, 10 different groups of 110 samples are used to derive measures of RMSE and R² and associated variability in these measures.

A key observation and reason that this model would be classified as “good” is that the standard deviation of the measures of RMSE and R² is quite stable. An example of a “bad” model would be one where variation of measures of RMSE and R² across different entries of data sets is large. The exact amount of variation to make this division is problem specific and may require the input of a problem domain expert.

Referring to FIG. 3 the calibrated Kernel Model 18 or 26 may now be used to predict a property associated with a new sample 30 of a substance that has previously been modelled. The process involves obtaining via a spectral device 31 a spectral reading 32 of the new sample 30.

The spectral device 31 may include a spectrophotometer as described above. The spectral reading 32 is again subjected to preprocessing 33 to normalize and denoise the raw spectral data. The processed spectra obtained from the new sample 30 are applied to the calibrated Kernel Model 34 obtained in step 18 or 26 above. The Kernel Model 34 outputs a sample report 35 that includes a predicted property (such as CaCO₃ content) for sample 30 based on Kernel Model 34.

Situations may arise in which the calibrated Kernel Model 34 is unable to interpret the spectral reading of the new sample 30. This may be because the spectral data and characteristic information stored in the spectral library 14 was obtained from a limited population of samples or the samples lacked sufficient variability in the property of interest to produce a robust Kernel Model 18 or 26. In such circumstances it is desirable to recalibrate the Kernel Model 18 or 26 or to create a new model taking into account the new sample 30.

Recalibration of the Kernel Model 18 or 26 may be performed whenever the output of the calibrated Kernel Model 34 cannot be interpreted correctly, or appears “suspect” for any reason eg. the spectra is predicted to have equal membership of all fuzzy sets.

A comparison 36 of the spectral reading for the new sample 30 may be performed with data stored in spectral library 14. The comparison 36 may include a comparison of maximum and minimum peaks of the new spectra with the maximum and minimum peaks stored in the spectral library 14. If the new spectra has minimums or maximums for any waveband that are below the global minimum and maximums on a particular waveband then this may indicate that the spectra is suspect. The suspect spectra will then need to be analysed by a non-spectral (eg. chemical) method and a new model 37 created having regard to the new sample 30.

As described above the Kernel learning process 17 or 23 is applied to training spectra and properties of substances stored in spectral library 14. The following is a description of an example of a Kernel learning process.

The spectra to be used to construct or calibrate the Kernel model, hereinafter called training spectra (processed or unprocessed) may be represented by a set of vectors of real numbers X and the properties of interest may be represented by a set of vectors of real numbers Y. For each X there is a matching Y but the relationship between X and Y is non-linear. Linear relationships between X and Y may be solved by prior art techniques, such as linear regression.

A significant aspect of the Kernel learning process is to map the input X into a non-linear space where a non-linear relationship between X and Y is made linearly separable. This is known as mapping X into a feature space. The Xs are the spectra where the property of interest Y is known. FIG. 4 shows a graphical representation of raw spectra 40-44 being mapped into the feature space via mathematical functions 45-49.

There may be more than one approach to creating this feature space and then learning the relationship between X and Y. Support Vector Methods such as SVMs and RVMs may use some combinations of X and Y to define an optimal linear separation between the transformed Xs and Ys in the feature space. Neural Network Methods (such as artificial neural networks using Kernel functions) may also be used but these adopt a different approach. An NNM has been successfully applied in a prototype system. The NNM used in the prototype system includes a Radial Basis Function Network (RBFN). An RBFN is composed of neurons which implement a Gaussian function such as:

$${G}_{i} ( x ) = exp \frac{- {\vert x - {μ}_{i} \vert}^{2}}{{σ}_{i}^{2}}$$

The learning process for NNM includes determining appropriate parameters for the kernel functions for several properties of a substance (eg. pH and cation exchange capacity in the case of soil) using approximately 1000 spectra. The specific kernel function and parameters appropriate for determining non-linear relationships between substance spectra (X) and its properties (Y) has to the applicant's knowledge not previously been used.

In the Support Vector Methods approach the training spectra X may be transformed or mapped onto a higher dimension space using kernel functions. A graphical representation of Kernel mapping using SVMs is shown in FIG. 5. The Kernel functions may include mathematical functions such as a Gaussian but could be polynomials, logarithms or other mathematical functions. During the learning process, a subset SV of the training spectra (X) are determined to be of particular importance as they lie near a separation line 50 that defines a boundary between classes of interest. One of the arguments of the mathematical functions at the conclusion of learning is the set SV (which is a subset of the training spectra X). When a new and unknown spectra Xi is presented, it may be transformed into higher dimensional space by a function. One example of such a function is the Gaussian:

$$exp \frac{- {\vert {x}_{i} - sv \vert}^{2}}{{σ}^{2}}$$

The unknown spectra may be represented by a set of vectors of real numbers Z. An ability to transform Z into this higher dimension space is known in the prior art (eg. Support Vector Machines, Radial Basis Function Neural Networks, etc.). Selection of a specific kernel function and associated parameters (such as sigma in the above Gaussian function) forms part of the learning process. The appropriate kernel functions and parameters are typically selected to be specific to analytical spectroscopy.

FIG. 6 shows a graphical representation of Kernel mapping using NNMs. The boundary that separates the classes of interest is now an arbitrary line 60 that provides a better fit to the population of transformed values.

A second step is to construct a linear relationship between the now linear X, Y and Z. A linear method (such as Partial Least Squares) may be applied to learn the now linear relationship. It is possible to learn the relationship between spectra and properties but spectra contain lots of information. If only relevant information is first extracted from the spectra then the learning process may have higher accuracy. As shown in FIG. 7 the amount of input can be reduced and the same learning methods can still be applied. Methods that can be used here include normalisation, first and second order derivatives of the spectral data, discrete wavelet transforms, principal component analysis and independent component analysis.

FIG. 8 shows examples of target output values being transformed into members of fuzzy sets. Unlike conventional set theory where elements are either a member or not a member of a set, fuzzy set theory introduces the concept of a “degree” of set membership, whereby a given element can simultaneously be a member of multiple fuzzy sets. This concept may allow greater flexibility when dealing with elements which are not crisp. Fuzzy sets are particularly useful when dealing with inherently problematic data such as that resulting from chemical analysis which typically has some kind of error bounds.

The fuzzy sets 1-4 shown in FIG. 8 include the following ranges:
Set 1: 5.5-7.4
Set 2: 7.0-7.9
Set 3: 7.5-8.4
Set 4: 8.0-8.9

As an example, set 1 may represent strongly base, set 2 may represent base neutral, set 3 may represent base acidic and set 4 may represent strongly acidic. Individual values may be assigned to one or more of these sets depending on the results of chemical tests.

In FIG. 8 fuzzy set classification is applied to three inputs: 6.5±0.4, 7.6±0.4 and 8.2±0.4. The inputs are transformed through the fuzzy sets 1:2:3:4 whose ranges are represented graphically. The range of values of sets 1:2, 2:3 and 3:4 overlap at centre values 7.2, 7.7 and 8.2 respectively. The first input (6.5±0.4) is classified into set 1 with degree 0.8, the second input (7.6±0.4) is classified into set 2 with degree 0.8 and into set 3 with degree 0.2 and the third input (8.2±0.4) is classified into set 3 with degree 0.5 and into set 4 with degree 0.5. The machine learning method of the present invention can be taught to predict the degree of fuzzy set membership. This may make errors that are associated with chemical data less problematic during the kernel learning process.

Finally, it is to be understood that various alterations, modifications and/or additions may be introduced into the constructions and arrangements of parts previously described without departing from the spirit or ambit of the invention.

1. A method for modelling a substance that has associated spectral data, said method including the steps of:
i) exposing a first sample of said substance to electromagnetic radiation having a range of wavelengths to obtain reflected spectral data from said substance;
ii) performing an analysis of said first sample to obtain characteristic information associated with said substance such as a physical or chemical property;
iii) repeating steps (i) and (ii) at least once on a second or further sample of said substance and storing said spectral data and characteristic information in a library; and
iv) generating from said library an individualized modelling equation for said substance as a function of said spectral data and characteristic information, wherein said modelling equation includes linear and non-linear dimensions and wherein said step of generating includes kernel learning means for reducing at least said non-linear dimensions associated with said modelling equation.

2. A method according to claim 1 wherein said second and further samples of said substance contain sufficient variability in a property of interest to produce spectral data that differs from or is at least not redundant when compared to said data stored in said library for other samples.

3. A method according to claim 1 wherein said step of generating is performed on a majority subset of data and information stored in said library and a minority subset of said data and information is removed for subsequent validation of said modelling equation.

4. A method according to claim 3 wherein said minority subset comprises approximately 10 percent of the data and information stored in said library.

5. A method according to claim 1 wherein said electromagnetic radiation includes visible, near infra-red (NIR), mid infra-red (MIR) and/or far infra-red (FIR) frequencies and/or combinations of such radiation.

6. A method according to claim 1 wherein said kernel learning means includes a machine learning process or algorithm such as a support vector machine (SVM), relevance vector machine (RVM) or an artificial neural network (ANN).

7. A method according to claim 1 wherein said kernel learning means includes kernel functions to determine non-linear relationships between identified independent components (inputs) and said material property of interest (output).

8. A method according to claim 7 wherein said kernel learning means creates non-linear models through an iterative algorithm including input/output pairs and learns said relationships between the inputs and output through repetition or training.

9. A method for modelling a property associated with a substance substantially as herein described with reference to the accompanying drawings.

10. A method of predicting a property associated with a substance including modelling spectral data according to claim 1 to generate an individualized modelling equation for said substance and utilizing said individualized modelling equation to predict said property.

11. A method for modelling a physical phenomenon that has associated spectral data, said method including the steps of:
i) obtaining said spectral data;
ii) performing an analysis of said phenomenon to obtain characteristic information associated with said phenomenon;
iii) repeating steps (i) and (ii) at least once on a second or further example of said phenomenon and storing said spectral data and characteristic information in a library; and
iv) generating from said library an individualized modelling equation for said phenomenon as a function of said spectral data and characteristic information, wherein said modelling equation includes linear and non-linear dimensions and wherein said step of generating includes kernel learning means for reducing at least said non-linear dimensions associated with said modelling equation.

12. A method according to claim 11 wherein said second and further examples of said phenomenon contain sufficient variability in a phenomenon of interest to produce spectral data that differs from or is at least not redundant when compared to said data stored in said library for other examples.

13. A method according to claim 11 wherein said step of generating is performed on a majority subset of data and information stored in said library and a minority subset of said data and information is removed for subsequent validation of said modelling equation.

14. A method according to claim 13 wherein said minority subset comprises approximately 10 percent of the data and information stored in said library.

15. A method according to claim 11 wherein said obtaining includes recording an electrical activity associated with a brain.

16. A method according to claim 11 wherein said characteristic information includes information about a brain or mental disorder.

17. A method according to claim 11 wherein said second and further examples are obtained from patients with mental disorders.

18. A method according to claim 11 wherein said electromagnetic radiation includes radio waves including extremely high frequency and extremely low frequency radio waves and near ultraviolet and gamma rays and/or combinations of such radiation.

19. A method according to claim 11 wherein said kernel learning means includes a machine learning process or algorithm such as a support vector machine (SVM), relevance vector machine (RVM) or an artificial neural network (ANN).

20. A method according to claim 11 wherein said kernel learning means includes kernel functions to determine non-linear relationships between identified independent components (inputs) and said material property of interest (output).

21. A method according to claim 20 wherein said kernel learning means creates non-linear models through an iterative algorithm including input/output pairs and learns said relationships between the inputs and output through repetition or training.

22. A method of predicting a physical phenomenon including modelling spectral data according to claim 11 to generate an individualized modelling equation for said phenomenon and utilizing said individualized modelling equation to predict said phenomenon.

23. A method according to claim 22 wherein said phenomenon includes a brain or mental disorder.
